(19) United States
(12) Patent Application Publication
(10) Pub. No.: US 2016/0341146 A1
(43) Pub. Date: Nov. 24, 2016

(54) Method, System and Apparatus for Dissipating Heat in Cylinder Head

(71) Applicant: Caterpillar Inc., Peoria, IL (US)

(72) Inventors: Curtis Graham, Peoria, IL (US); Taylor Young, Peoria, IL (US)

(73) Assignee: Caterpillar Inc., Peoria, IL (US)

(21) Appl. No.: 14/719,787

(22) Filed: May 22, 2015

(51) Int. Cl. F02F 1/00; F02F 3/00; F02F 7/00; F02F 1/42

(52) U.S. Cl. CPC F02F 1/004; F02F 1/42; F02F 3/00; F02F 7/0085

(57) ABSTRACT

An engine includes a cylinder block having at least one cylinder bore, a piston positioned in the cylinder block, and a cylinder head configured to attach to the cylinder block at a mounting surface of the cylinder block, the cylinder head including a corresponding mounting surface, a first valve receiving portion and a second valve receiving portion, each valve receiving portion being disposed on the mounting surface of the cylinder head, a bridge disposed between the first valve receiving portion and the second valve receiving portion, at least one channel disposed through at least a portion of the bridge, and a heat transferring material positioned within the at least one channel, the heat transferring material having a first thermal conductivity, wherein the cylinder head is formed of a parent material having a second thermal conductivity.

### TECHNICAL FIELD

The disclosure relates generally to cylinder heads for machine engines, and relates more particularly to cylinder heads adapted to dissipate heat in targeted areas.

### BACKGROUND

An internal combustion engine, such as a diesel, gasoline, or natural gas engine, typically includes a cylinder head and a cylinder block that together, along with a combustion face of a piston, define at least one combustion chamber. The cylinder head may include at least one of each of an intake and exhaust valve positioned therein that are actuated to allow the flow of intake and exhaust gases to and from the combustion chambers. Valve ports are provided with valve seats located on the cylinder head to receive the valves in order to seal the combustion chamber. The valve ports may be configured in groups and in proximity to each other in order to operate with each combustion chamber.

It is frequently desirable that the valve ports be as large as possible within the constraints of the space permitted by the diameter of the combustion chamber in order to maximize the flow into and from the combustion chamber. Because of this desire, a relatively narrow bridge of cylinder head material may form the separation between the valve ports on the cylinder head. During operation of the internal combustion engine, the bridge of cylinder head material can develop cracks if the heat from the combustion of fuel cannot be sufficiently transferred in these narrow bridges to or from other portions of the cylinder head.

U.S. Pat. No. 7,677,218 (the “'218 patent”), entitled “Cylinder head including stress channel with filler,” provides a solution for relieving stress to the cylinder head caused by combustion. The '218 patent discloses the use of stress channels in the bottom surface that may extend between adjacent openings in the cylinder head, in between combustion chambers, to relieve stresses. The '218 patent also discloses the use of a seal for mitigating fire ring blow-out which can occur in cylinder heads with stress channels. While the '218 patent provides such a solution, there may be some applications in which it is desirable to vary thermal conductivity in targeted areas within a cylinder head.

### SUMMARY

According to an aspect of the disclosure, an engine includes a cylinder block having at least one cylinder bore, a piston positioned in the cylinder block, and a cylinder head configured to attach to the cylinder block at a mounting surface of the cylinder block. The cylinder head includes a corresponding mounting surface and a first valve receiving portion and a second valve receiving portion disposed on the mounting surface of the cylinder head. A bridge is disposed between the first valve receiving portion and the second valve receiving portion and at least one channel is disposed through at least a portion of the bridge. A heat transferring material is positioned within the at least one channel, the heat transferring material has a first thermal conductivity, and the cylinder head is formed of a parent material having a second thermal conductivity.

According to another aspect of the disclosure, a cylinder head includes a mounting surface, a first valve receiving portion, and a second valve receiving portion, each valve receiving portion being disposed on the mounting surface. A bridge is disposed between the first valve receiving portion and the second valve receiving portion and at least one channel is disposed through at least a portion of the bridge. The at least one channel is located above the mounting surface and a heat transferring material is positioned within the at least one channel. The heat transferring material has a first thermal conductivity and the cylinder head is formed of a parent material having a second thermal conductivity.

According to another aspect of the disclosure, a method for modifying thermal conductivity in a cylinder head of an engine includes forming at least one channel within a cylinder head above a mounting surface of the cylinder head and positioning at least one material into the at least one channel within the cylinder head. The at least one material has a first thermal conductivity that differs from a thermal conductivity of the cylinder head.

### BRIEF DESCRIPTION OF THE DRAWINGS

FIG. 1 provides a side view of an engine as defined in accordance with an aspect of the present disclosure.

FIG. 2 provides a bottom view of a mounting surface of an exemplary conventional cylinder head.

FIG. 3 provides a cutaway view of the cylinder head taken along the lines of FIG. 2.

FIG. 4 provides a detailed view of the portion of the cylinder head contained within the circle identified by reference label IV in FIG. 2.

FIG. 5 provides a cutaway view of the cylinder head taken along the lines of FIG. 2, modified in accordance with an aspect of the present disclosure.

FIG. 6 provides a side view of the cylinder head, according to an aspect of the present disclosure.

FIG. 7 provides a cutaway view of the cylinder head taken along lines VII-VII of FIG. 6.

### DETAILED DESCRIPTION

Aspects of the disclosure will now be described in detail with reference to the drawings, wherein like reference numbers refer to like elements throughout, unless specified otherwise.

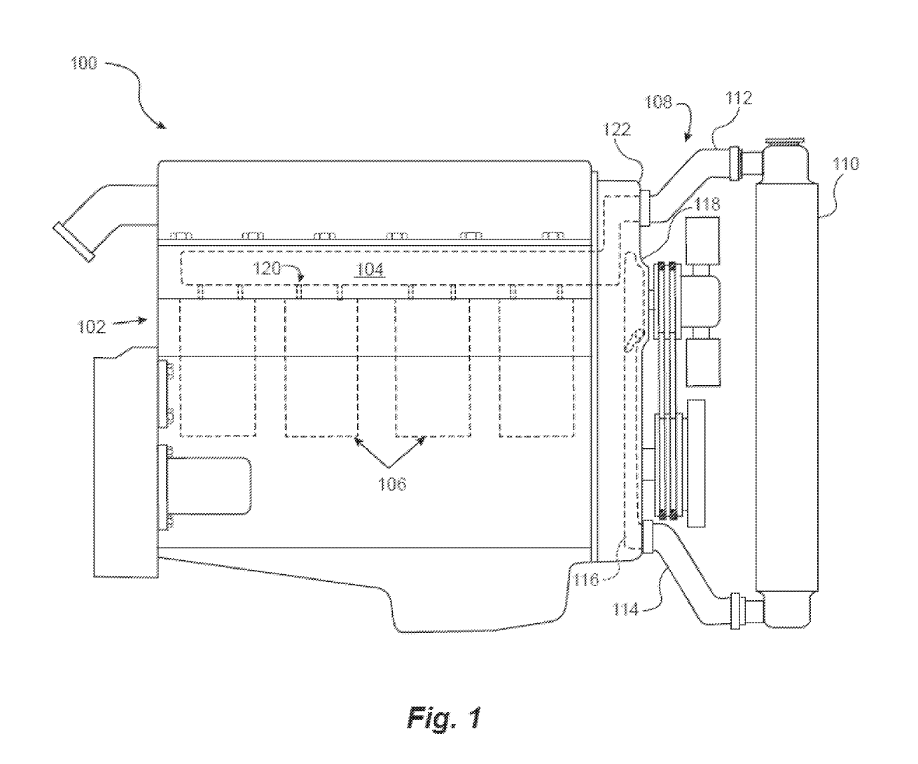

FIG. 1 illustrates an engine 100 that has a cylinder block 102. The engine 100 also includes cylinder head 104, combustion chambers 106 defined by the cylinder block 102, the cylinder head 104, and a piston combustion face (not shown). A cooling system 108 is also included in the engine 100 and may have a heat exchanger 110, an upper hose 112, and a lower hose 114 to connect the heat exchanger 110 to the engine 100. The heat exchanger 110 may be connected to both the lower hose 114 and to a passage 116 which communicates with a cooling transfer pump 118. The cooling system 108 may further include a plurality of passages 120 and an outlet manifold 122.

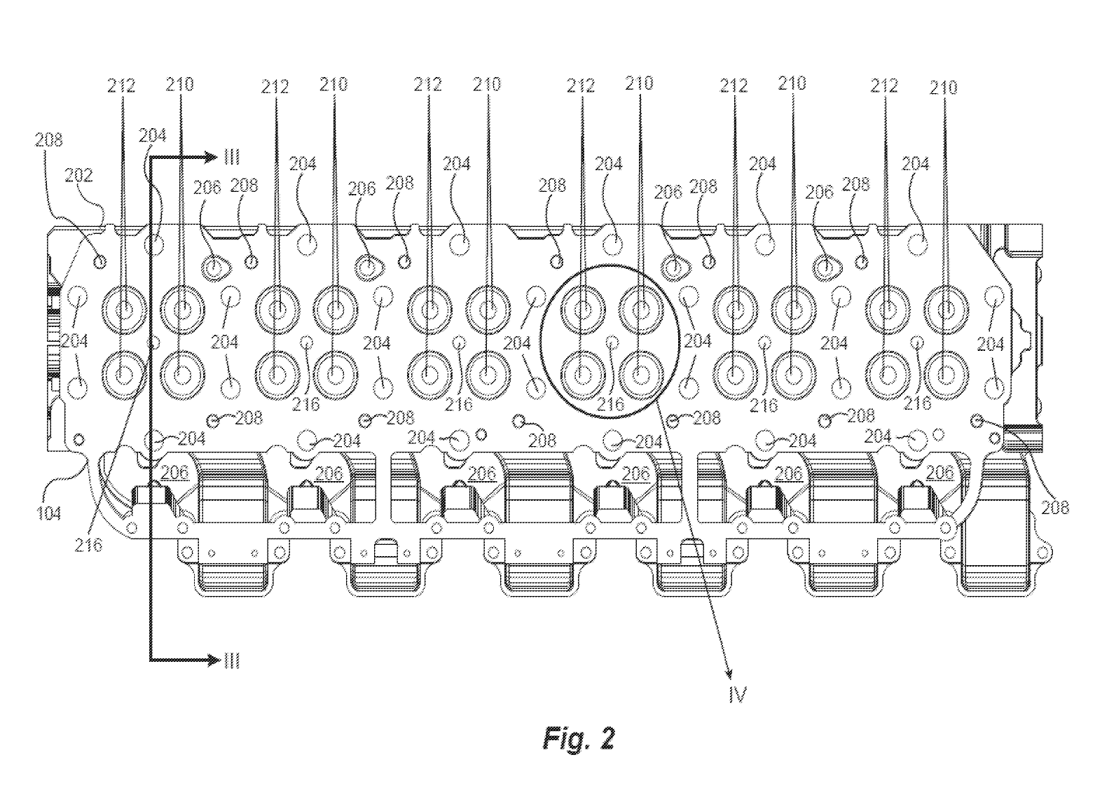

As shown more clearly in FIG. 2, the cylinder head 104 for the engine 100 includes a variety of ports or receiving portions disposed on the mounting surface of the cylinder head 104, hereafter referred to as the mounting surface 202, that mounts to the cylinder block 102. The ports depicted in the cylinder head 104 in FIG. 2 include head bolt ports 204 which may receive fasteners such as bolts or the like for mounting the cylinder head 104 to the cylinder block 102. In one aspect of the present disclosure, the cylinder head 104 may have oil head back ports 206 for the transmission of oil. In addition, the cylinder head 104 may have water passage ports 208 which may allow engine coolant to pass through the cylinder head 104, thereby transferring heat away from the cylinder head 104 to the heat exchanger 110 of FIG. 1 and cooling the cylinder head 104. The cylinder head ports may also include intake valve ports 210 and exhaust valve ports 212, each corresponding to one or more intake valves and exhaust valves, respectively.

Additionally, the cylinder head 104 may have one or more injection ports 216 for each set of intake valve ports 210 and exhaust valve ports 212. While the cylinder head 104 of FIG. 2 has one injection port 216, an alternative aspect of the present disclosure may include two or more injection ports 216 for each set of intake valve ports 210 and exhaust valve ports 212.

Each combustion chamber 106 (FIG. 1) may be associated with one or more of the intake valves and one or more of the exhaust valves. In the exemplary aspect of FIG. 2, each combustion chamber 106 is associated with a pair of intake valves corresponding to a pair of intake valve ports 210, and a pair of exhaust valves corresponding to a pair of exhaust valve ports 212.

The cylinder head 104 is configured to receive the set of valves associated with each combustion chamber 106. The intake valve ports 210 and the exhaust valve ports 212 receive the intake valves and the exhaust valves, respectively. An intake valve selectively blocks each intake valve port 210 and may be actuated by a respective lobe of a camshaft to move a valve element to open and close the associated intake valve port 210. Likewise, an exhaust valve selectively blocks each exhaust valve port 212 and may be actuated by another lobe on the same or another camshaft to open and close the associated exhaust valve port 212.

Each combustion chamber 106 is also associated with an injection port 216 which extends through the mounting surface 202 of the cylinder head 104. The injection port 216 receives a fuel injector to spray fuel through the cylinder head 104 into the combustion chamber 106. It is noted that, although depicted as a cylinder head 104 for a diesel engine, the disclosure is not limited to such an application. The cylinder head 104 may alternatively be constructed in accordance with aspects of the present disclosure for use in gasoline or other fuel engines requiring such an ignition source.

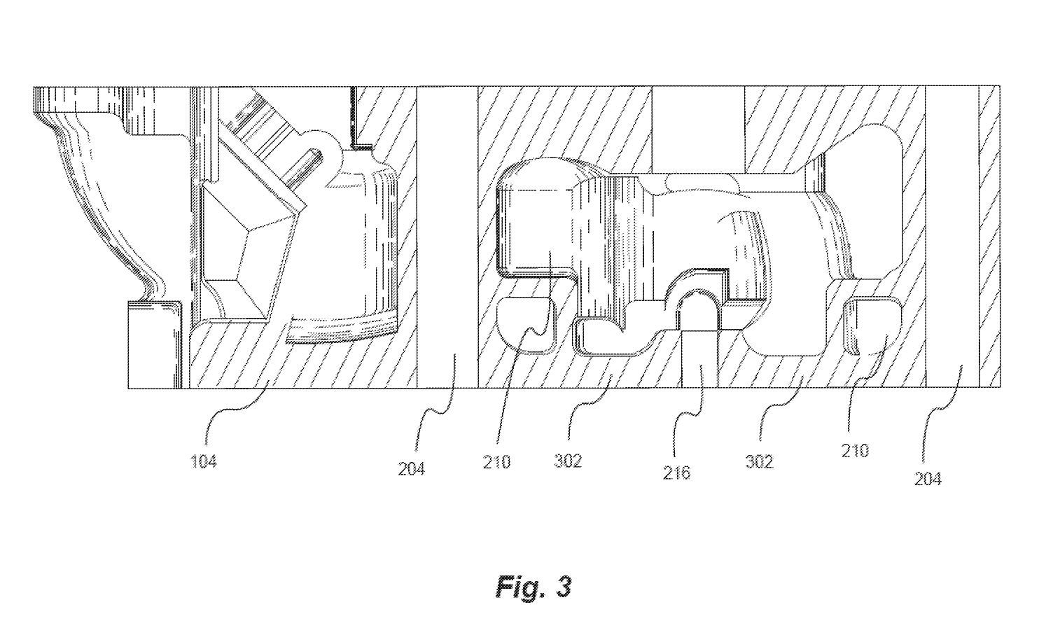

As shown in FIG. 3, the intake valve ports 210 in the cylinder head 104 and the injection port 216 associated with a combustion chamber 106 each extend through the mounting surface 202. Narrow bridges 302 of material exist between the ports. The bridges 302 may consist of materials structurally suitable for the application, such as, for example, aluminum, magnesium, iron, steel and other alloys, carbon fiber, or the like. These materials possess beneficial properties but may also have thermal conductivity that is not ideal in the area of the bridges 302 due to the variation in temperatures during the operation of the engine 100. Due in part to the size of the ports and to the relatively limited amount of material in the bridge 302, the bridge 302 has a limited capacity to transfer heat to or from the bridges 302. As a result, damage to the bridge 302 and/or other components of the engine 100 may occur over time.

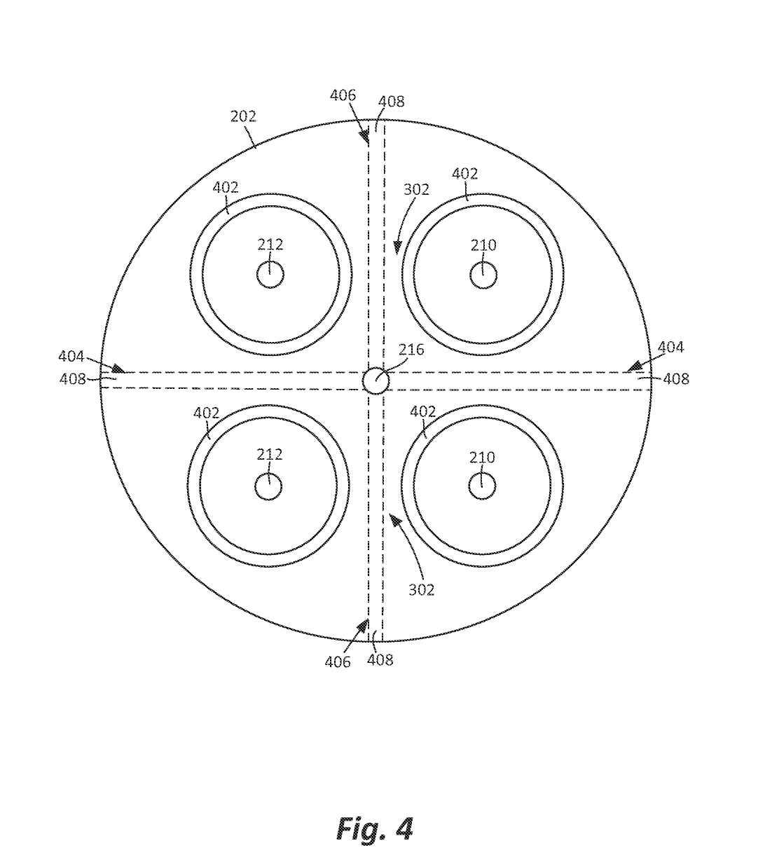

FIG. 4 is a detailed view of a portion of a cylinder head as indicated in FIG. 2. This portion of the mounting surface 202 of the cylinder head 104 corresponds with a combustion chamber 106 (FIG. 1) and contains a pair of intake valve ports 210, a pair of exhaust valve ports 212, and an injection port 216. Each pair of intake valve ports 210 and pair of exhaust valve ports 212 has a valve seat 402 for the corresponding valve elements.

As illustrated in FIG. 4, the bridges 302 may have relatively lower thermal mass than surrounding structures and/or a limited ability to regulate the heat of the bridges 302 by, for example, transferring the heat to other portions of the cylinder head 104 and the cylinder block 102. To account for the relatively low thermal mass of the bridge 302, channels 404 and 406 may be machined into the cylinder head 104 through the bridges 302 and spaced from the mounting surface 202 so that each channel 404 and 406 is separated from the mounting surface 202 by some amount of a parent material of the cylinder head 104. As will be described in more detail below, heat sinks 408 may be positioned in the channels 404 and 406.

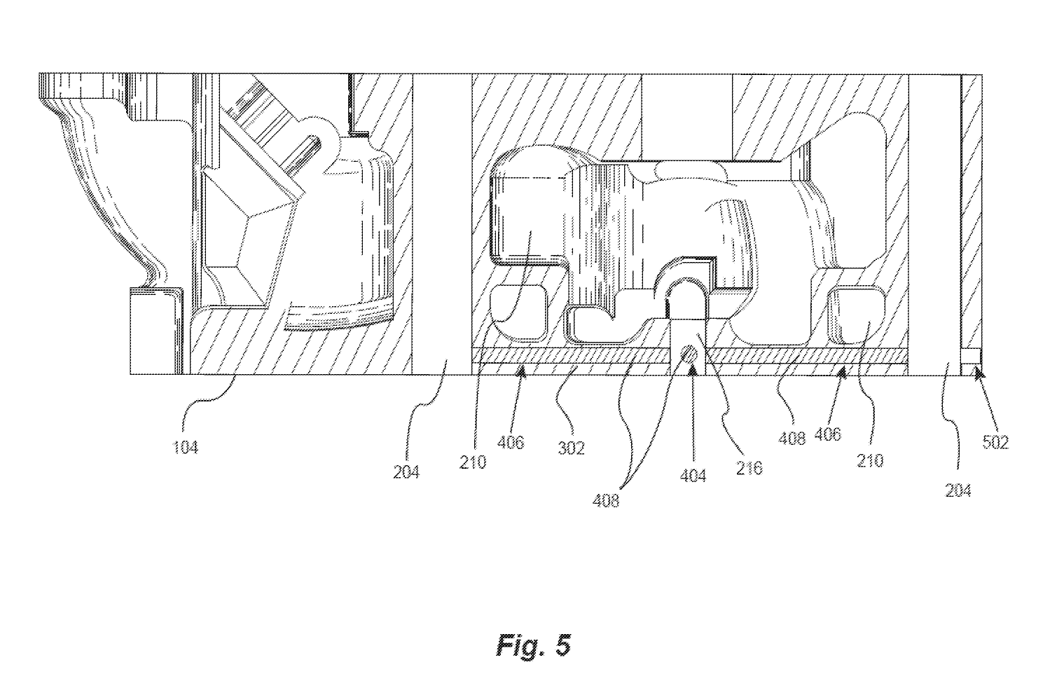

In accordance with an aspect of the present disclosure, the cylinder head 104 of FIG. 5 has been modified to include the channels 404, 406, and 502. The channels 406 and 502 may be formed together by drilling or machining through a side of the cylinder head 104 and through one or more ports 204, 216. Although described as drilled or machined, in some aspects of the disclosure, the channels 404, 406, and/or 502 may be otherwise provided within the cylinder head 104. In FIG. 5, the channel 502 has been machined from a side of the cylinder head 104 through the first bolt head port 204, through the injection port 216, and up to the second bolt head port 204. The channels 406 are disposed between each bolt head port 204 and the injection port 216. As will be described below, the channel 404 may be formed by machining along another axis of the cylinder head 104.

In one aspect of the present disclosure, heat sinks 408 are positioned in the channels 404, 406, and 502 by inserting rods of heat sink material. In order to prevent the heat sinks 408 from obstructing the injection port 216 and/or the bolt head port 204, the injection port 216 and/or bolt head port 204 may be machined after the heat sink 408 has been positioned in the channels 406. In various aspects, the channel 502 may contain a heat sink 408 or be used as a conduit for the insertion of the heat sink 408 and then be plugged.

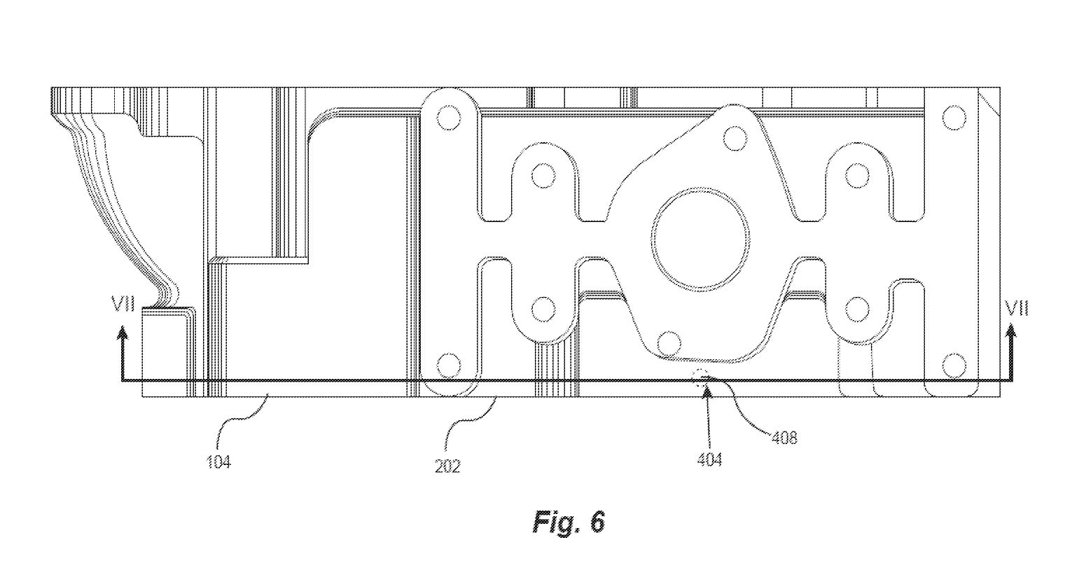

FIG. 6 illustrates a side view of the cylinder head 104. In this side view of the cylinder head 104, the channel 404 can be seen as separated from the mounting surface 202 by the parent material of the cylinder head 104. To prevent the heat sink 408 from obstructing the injection port 216 when the heat sink 408 is positioned in the channel 404, the injection port 216 through which channel 404 may need to be drilled may be machined after the channel 404 has been drilled and after the heat sink 408 has been inserted into the channel 404.

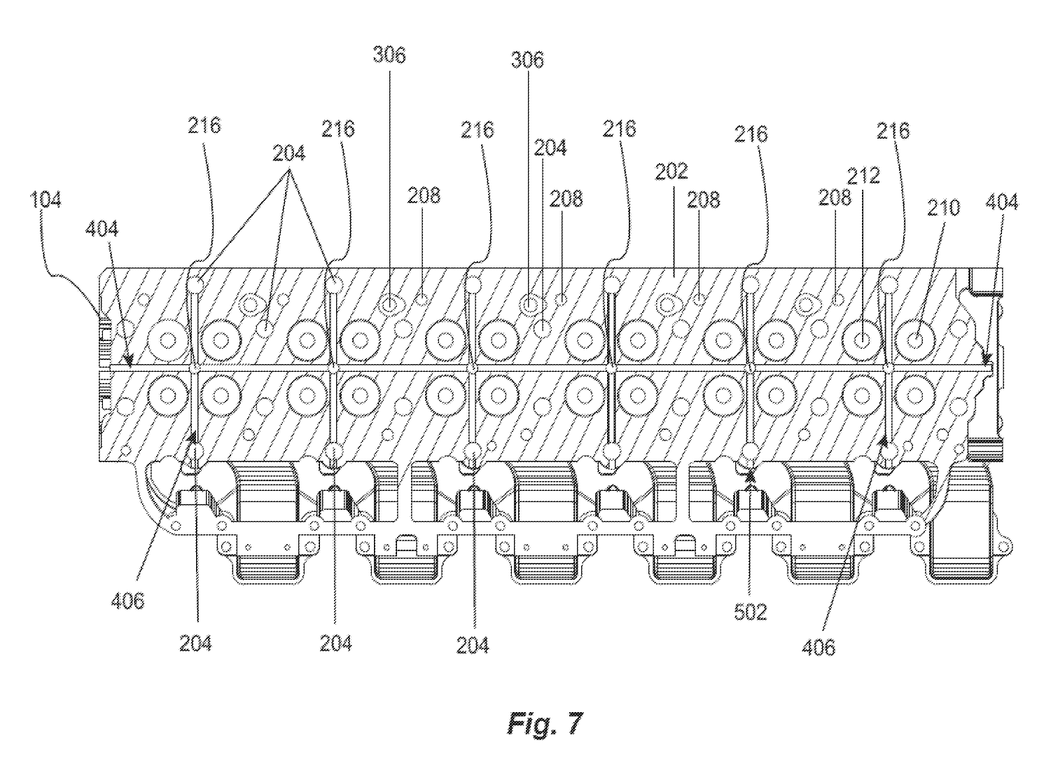

An exemplary configuration of channels 404, 406, and 502 in the cylinder head 104 is illustrated in FIG. 7, which shows a cutaway view of the cylinder head 104 of FIG. 6. The cutaway view of the cylinder head 104 in FIG. 7 illustrates a two-dimensional view of the channels 404, 406, and 502. In this example, the channels 404 extend from each injection port 216 along a lateral axis that extends from the front of the cylinder head 104 to the back of the cylinder head 104 and through each of the injection ports 216. The channels 406 are positioned along longitudinal axes which extend from one side of the cylinder head 104 to another side of the cylinder head 104 and through each of the injection ports 216.

Thus, the channels 404 are positioned between each injection port 216 so that the channels 404 align with the injection ports 216 and are perpendicular to the channels 406, which are positioned between the bolt head ports 204 and the injection ports 216. The result of such a configuration is, as shown in FIG. 7, four different channels 404 and 406 extending from each injection port 216. The positioning of the channels 404 and 406 on the axes in FIG. 7 results in the positioning of heat sinks 408 near the bridges 302 and in between the intake valve ports 210 and the exhaust valve ports 212.

The number of the channels 404 and 406 may vary based on a number of factors such as the size of the cylinder head 104, the amount of material that exists in the bridge 302 in between the intake valve ports 210 and the exhaust valve ports 212, and the number of combustion chambers 106 associated with the engine 100. The volume, length, and direction of the channels 404 and 406 may also vary. The channels 404 and/or 406 may be cylindrical, fluted or otherwise shaped to receive the rods formed by the heat sinks 408. Although not shown, in another aspect of the disclosure, the water passage ports 208 may intersect with the channels 404 and 406 to allow for more transferring of cooling material within the cylinder head 104.

In alternative aspects, the channels 404 and/or 406 may have heat sinks 408 of varying thermal characteristics in different locations within the cylinder head 104. For example, the heat sinks 408 positioned in the channels 404 may have a different thermal conductivity than the heat sinks 408 positioned in the channels 406. Alternatively, each of the channels 404 and/or 406 may have one or more portions with heat sinks 408 having one thermal conductivity and one or more portions that are filled with the parent material or heat sinks 408 having a different thermal conductivity.

In some applications, after the channels 404 and 406 have been drilled, each heat sink rod 408 may be formed in sections no longer than its corresponding channels 404 or 406. In such applications, the heat sink rods 408 may be inserted in steps so that each heat sink rod 408 is no longer than the length of the channel 404 or 406 in which it is positioned and so that the heat sink rods 408 do not obstruct the injection ports 216 and/or bolt head ports 204, thus minimizing the number of machining steps. Alternatively, the channels 404 and 406 may be molded or cast into the cylinder head 104 to allow for heat sinks 408 in multiple axial directions and separated from the mounting surface 202 by the parent material of the cylinder head 104. In another aspect, the heat sink 408 may be poured into or otherwise positioned in the channels 404 and 406 before machining the injection ports 216 and/or bolt head ports 204.

Still in other applications, it may be desirable to position heat sinks 408 into the cylinder head 104 at different angles than those shown in FIG. 7. These alternative applications may require multiple steps of drilling into the cylinder head 104, positioning the heat sinks 408, machining, and/or plugging the injection ports 216 and/or bolt head ports 204 and/or other portions of the cylinder head 104.

In another aspect of the present disclosure, it may be desirable to position a sleeve or other sealing mechanism in the injection port 216 to isolate the channels 404 and 406 from the injection port 216. The sleeve could be a grommet, gasket, or the like and may be metal, carbon fiber, or the like. The sleeve may provide structural support for the injection port 216 and may be removable to allow for the replacement of the heat sinks 408.

In some aspects, the heat sinks 408 may be copper or any other material with a higher thermal conductivity than the thermal conductivity of the parent material of the bridge 302 of the cylinder head 104. For example, if the bridge 302 parent material is iron (80 W/(m*K) at 25° C.), copper would provide a higher thermal conductivity (401 W/(m*K) at 25° C.) than the iron cylinder head 104 when used as the heat sink 408. In other examples, aluminum (205 W/(m*K) at 25° C.), zinc (116 W/(m*K) at 25° C.), magnesium (156 W/(m*K) at 25° C.), and the like having relatively high thermal conductivity may be used as the heat sinks 408. In alternative aspects, it may be desirable to utilize heat sinks 408 having lower thermal conductivity than the parent material.

Alternatively, some of the heat sinks 408 may use a combination of materials with different thermal conductivities in different locations to allow targeted temperature regulation within the cylinder head 104. For example, the heat sink 408 positioned into channels 406 may have a thermal conductivity that is different from the heat sink 408 positioned into channels 404 in order to customize or otherwise modify the regulation of heat within the cylinder head 104 at different locations and/or to transfer heat in a particular direction, among other reasons. The customized regulation of thermal conductivity within the cylinder head 104 may also provide a thermal uniformity across the cylinder head 104 and thus reduce thermal stresses on the various components of the cylinder head 104. It may also be desirable in some applications to consider other material properties for the heat sinks 408, such as heat capacity, hardness, malleability, melting point, galvanic response, expansion coefficient, and the like.

### INDUSTRIAL APPLICABILITY

This disclosure could be applied to any engine 100 or other systems having an engine 100 using valve actuation. The apparatus, system, and process may increase engine efficiency, reduce wear of the cylinder head 104, and improve performance of the cylinder head 104 and related components.

Turning to FIG. 4 and FIG. 7, the cylinder head 104 may have one or more heat sink rods 408 positioned in the channels 404 and/or 406 to regulate the temperature of the cylinder head 104. As the engine 100 associated with the cylinder head 104 operates, uneven or cyclic heating applied to areas of low thermal mass may cause thermal stress in the cylinder head 104, particularly in the bridge 302 between the intake valve ports 210 and the exhaust valve ports 212 associated with each combustion chamber 106. In order to reduce damage caused by thermal stress, the heat sink rods 408 provided in the cylinder head 104 may be utilized to modulate the thermal conductivity in and around the bridge 302 to reduce temperature differences between the bridge 302 and surrounding structures. In this manner, thermal stresses and/or thermally induced shear forces may be reduced at the bridge 302.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An engine comprising:
a cylinder block having at least one cylinder bore;
a piston positioned in the cylinder block; and
a cylinder head configured to attach to the cylinder block at a mounting surface of the cylinder block, the cylinder head including:
a mounting surface;
a first valve receiving portion and a second valve receiving portion, each valve receiving portion being disposed on the mounting surface of the cylinder head;
a bridge disposed between the first valve receiving portion and the second valve receiving portion;
at least one channel disposed through at least a portion of the bridge; and
a heat transferring material positioned within the at least one channel, the heat transferring material having a first thermal conductivity, wherein the cylinder head is formed of a parent material having a second thermal conductivity.

2. The cylinder head of claim 1, wherein the heat transferring material forms at least one rod within the cylinder head.

3. The cylinder head of claim 1, further comprising:
an injection receiving portion disposed between the first valve receiving portion and the second valve receiving portion, the injection receiving portion being disposed on the mounting surface of the cylinder head.

4. The cylinder head of claim 3, wherein the at least one channel extends axially from the injection receiving portion in a direction that is oriented perpendicular to the injection receiving portion.

5. The cylinder head of claim 3, wherein the at least one channel extends from the injection receiving portion to another injection receiving portion within the cylinder head.

6. The cylinder head of claim 3, further comprising a seal between the at least one channel and the injection receiving portion.

7. A cylinder head for an engine, the cylinder head comprising:
a mounting surface, a first valve receiving portion, and a second valve receiving portion, each valve receiving portion being disposed on the mounting surface;
a bridge disposed between the first valve receiving portion and the second valve receiving portion;
at least one channel disposed through at least a portion of the bridge, the at least one channel located above the mounting surface; and
a heat transferring material positioned within the at least one channel, the heat transferring material having a first thermal conductivity, wherein the cylinder head is formed of a parent material having a second thermal conductivity.

8. The cylinder head of claim 7, wherein the heat transferring material forms at least one rod within the cylinder head.

9. The cylinder head of claim 7, further comprising an injection receiving portion disposed on the mounting surface.

10. The cylinder head of claim 9, wherein the at least one channel extends axially from the injection receiving portion in a direction that is oriented perpendicular to the injection receiving portion.

11. The cylinder head of claim 9, wherein the at least one channel extends from the injection receiving portion to another injection receiving portion within the cylinder head.

12. The cylinder head of claim 9, further comprising a seal between the at least one channel and the injection receiving portion.

13. A method for modifying a thermal conductivity in a cylinder head of an engine, the method comprising:
forming at least one channel within a cylinder head above a mounting surface of the cylinder head; and
positioning at least one material into the at least one channel within the cylinder head, the at least one material having a first thermal conductivity that differs from a thermal conductivity of the cylinder head.

14. The method of claim 13, wherein positioning the at least one material further comprises positioning the at least one material in between a first valve receiving portion and a second valve receiving portion, each valve receiving portion being disposed on the mounting surface of the cylinder head.

15. The method of claim 14, wherein the cylinder head comprises an injection receiving portion in between the first valve receiving portion and the second valve receiving portion, each injection receiving portion being disposed on the mounting surface of the cylinder head.

16. The method of claim 15, wherein forming the at least one channel further comprises forming the at least one channel between the first valve receiving portion and the second valve receiving portion.

17. The method of claim 15, further comprising forming the at least one channel to extend axially from the injection receiving portion in a direction that is oriented perpendicular to the injection receiving portion.

18. The method of claim 15, further comprising forming the at least one channel from the injection receiving portion to another injection receiving portion within the cylinder head.

19. The method of claim 13, wherein positioning the at least one material into the at least one channel comprises drilling the at least one channel through the injection receiving portion, inserting the at least one material into the injection receiving portion, and machining the injection receiving portion.

20. The method of claim 13, further comprising forming at least one rod with the at least one material within the cylinder head.
